(19) United States
(12) Patent Application Publication
(10) Pub. No.: US 2022/0254249 A1
(43) Pub. Date: Aug. 11, 2022

(54) TRAFFIC EVENT AND ROAD CONDITION IDENTIFICATION AND CLASSIFICATION

(71) Applicant: VALERANN LTD., Tel Aviv (IL)

(72) Inventors: Avi TEL-OR, Aseret (IL); Ido GLANZ, Tel Aviv (IL); Lior SIMCHON, Tel Aviv (IL); Shahar BAHIRI, Tel Aviv (IL); Ran KATZIR, Ramat Hasharon (IL)

(73) Assignee: VALERANN LTD., Tel Aviv (IL)

(21) Appl. No.: 17/624,592

(22) PCT Filed: Jul. 2, 2020
(86) PCT No.: PCT/IL2020/050741

§ 371 Date: Jan. 4, 2022

(30) Foreign Application Priority Data
Jul. 5, 2019 (GB) 1909690.8

(51) Int. Cl. G08G 1/01; G08G 1/0962

(52) U.S. Cl. CPC G08G 1/0116; G08G 1/0962; G08G 1/0133; G08G 1/0112

(57) ABSTRACT

A system and a method for automatically identifying and classifying traffic and road events, by collecting metrics regarding one or more monitored vehicles from at least one of: a plurality of stationary traffic sensors installed on or proximate to a discrete segment of a road; traffic monitoring infrastructure; and, one or more connected vehicles. The system and a method are further to determine a position and a speed of each monitored vehicle per discrete segment in each lane of said road; and, identify, classify and localize one or more traffic and road events on said road. The identifying and classifying includes the steps of: training one or more machine learning algorithms to derive traffic and road events; and, associating, using said one or more machine learning algorithms, one or more observed traffic and road events with a known class of traffic and road events.

### FIELD OF THE INVENTION

The present invention relates generally to traffic monitoring and management, and more particularly to identifying and classifying road conditions and traffic related incidents.

### BACKGROUND OF THE INVENTION

Owing to a growing prevalence in vehicle accessibility and ownership, the amount of vehicles found on highways, motorways and the like is increasingly problematic. Various road safety and traffic management measures have been employed to ameliorate congestion arising from, for example, collisions, weather related incidents and the like; however these measures are known to necessitate an undesirable degree of user/driver action or intervention.

For example, it is commonplace in the art for drivers to encounter road related incidents/events and to report them to an authority or intervention agency, thereby proliferating awareness. Historically, reporting may have been conducted by phoning or texting an appropriate contact number; however, in more recent years, smart phone applications have been developed to facilitate and expedite this purpose.

In alternative arrangements, road bound monitoring infrastructure, such as networked camera monitoring systems, have been deployed and utilized in some locations. These monitoring systems are, however, generally known to be impractical owing to a necessity for manual operator control and feed review. Artificial intelligence (AI) techniques have therefore been developed to review/analyze the aforesaid camera feeds from road bound monitoring infrastructure. Such techniques are however known to be inaccurate and/or unreliable as a consequence of, for example, partial camera coverage and/or feed obfuscating weather events (e.g., fog, hailstorms).

Vehicle bound sensor systems and automated inter-vehicle (V2V) communication systems have also been developed and are becoming increasingly common, however it will be some time before sufficient, or indeed all, vehicles are equipped with these facilities. Further, even in the event that all vehicles are equipped with such facilities, inaccuracies may arise in such sensor systems as a consequence of, for example: missing/failed sensing components; improper data synchronization; and/or, visibility losses/interference.

It is therefore an object of the invention to propose a low-cost, scalable, reliable, safe and automated system for traffic and road condition identification and classification. It is a further object of the invention to propose a secured and easily used/accessed system readily suited to installation/incorporation into any portion of a rural and/or major road network.

### SUMMARY OF THE PRESENT INVENTION

A method for automatically identifying and classifying traffic and road events is disclosed herein. The method comprises: collecting metrics regarding one or more monitored vehicles from at least one of: a plurality of stationary traffic sensors installed on or proximate to a discrete segment of a road; traffic monitoring infrastructure; and, one or more connected vehicles; determining a position and a speed of each monitored vehicle per discrete segment in each lane of said road; and, identifying, classifying and localizing one or more traffic and road events on said road.

A system for automatically identifying and classifying traffic and road events is also disclosed herein. The system comprises: a plurality of stationary traffic sensors installed on or proximate to a discrete segment of a road, wherein each one of said plurality of stationary traffic sensors comprises: a communication module for transmitting metrics data to at least one remote processing facility; and, a sensing module for capturing metrics data regarding one or more monitored vehicles; and, at least one remote processing facility comprising one or more computer processors each having computer readable storage media and program instructions stored thereon for execution by said one or more computer processors, the program instructions comprising: instructions to receive metrics data from one or more of: said plurality of stationary traffic sensors; traffic monitoring infrastructure; and, one or more connected vehicles; instructions to determine a position and a speed of each monitored vehicle per discrete segment in each lane of said road; and, instructions to identify, classify and localize one or more traffic and road events on said road.

Advantages of the present invention are set forth in detail in the following description.

### BRIEF DESCRIPTION OF THE DRAWINGS

For a better understanding of the invention and in order to show how it may be implemented, references are made, purely by way of example, to the accompanying drawings in which like numerals designate corresponding elements or sections. In the accompanying drawings:

FIG. 1 is a schematic diagram illustrating exemplary non-limiting architecture of a system for traffic and road condition identification and classification according to embodiments of the present invention.

FIGS. 2A and 2B are schematic diagrams illustrating metrics/class obtained in an exemplary system for traffic and road condition identification and classification according to embodiments of the present invention.

FIG. 3 is a schematic diagram illustrating an exemplary processing pathway in a system for traffic and road condition identification and classification according to embodiments of the present invention.

FIG. 4 is a schematic diagram illustrating exemplary segmented vehicle speed assessment in a system for traffic and road condition identification and classification according to embodiments of the present invention.

FIG. 5 is a schematic diagram illustrating exemplary road tensor assessment in a system for traffic and road condition identification and classification according to embodiments of the present invention.

FIG. 6 is a schematic diagram illustrating an exemplary computational method for identifying and classifying traffic and road conditions according to embodiments of the present invention.

FIG. 7 is a schematic diagram illustrating an exemplary traffic and road condition classification according to embodiments of the present invention.

FIG. 8 is a schematic diagram illustrating exemplary progression of a traffic and road condition classification over time according to embodiments of the present invention.

FIG. 9 is a schematic diagram illustrating an exemplary traffic and road condition classification according to embodiments of the present invention.

FIG. 10 is a schematic diagram illustrating exemplary progression of a traffic and road condition classification over time according to embodiments of the present invention.

FIG. 11 is a schematic diagram illustrating exemplary prediction of a traffic and road condition according to embodiments of the present invention.

FIG. 12 is a schematic diagram illustrating an exemplary means for obtaining metrics data directly from connected vehicles according to embodiments of the present invention.

FIGS. 13 and 14 are schematic diagrams illustrating an exemplary means for identifying and classifying traffic and road events using polynomial K-means clustering according to embodiments of the present invention; and

FIG. 15 is a schematic flow diagram illustrating an exemplary computational method for identifying and classifying traffic and road conditions according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

With specific reference now to the drawings in detail, it is stressed that the particulars shown are for the purpose of example and solely for discussing the preferred embodiments of the present invention, and are presented in the cause of providing what is believed to be the most useful and readily understood description of the principles and conceptual aspects of the invention. In this regard, no attempt is made to show structural details of the invention in more detail than is necessary for a fundamental understanding of the invention. The description taken with the drawings makes apparent to those skilled in the art how the several forms of the invention may be embodied in practice.

Before explaining the embodiments of the invention in detail, it is to be understood that the invention is not limited in its application to the details of construction and the arrangement of the components set forth in the following descriptions or illustrated in the drawings. The invention is applicable to other embodiments and may be practiced or carried out in various ways. Also, it is to be understood that the phraseology and terminology employed herein is for the purpose of description and should not be regarded as limiting.

The following term definitions are provided to aid in construal and interpretation of the invention.

The terms “condition”, “event” and “issue” are used interchangeably herein to refer to an observable, inferable or calculable occurrence and/or situation. In the present context, these terms may denote a serious or merely notable road bound or road related occurrence, for example such as a stalled vehicle, a localized weather event, or the like.

The term “metrics” refers generally to observable and quantifiable measurements which may be recorded/taken, for example using a discrete and/or interconnected sensing device, and used for subsequent analysis/processing. In the present context, a plurality of different “metrics” are collected and analyzed, generally in correspondence with each other, for the purposes of identifying and classifying traffic and/or road events/incidents. A non-exhaustive list of metrics which may be collected includes: peak magnitude of magnetic field change (e.g., arising as a consequence of a passing vehicle); peak magnitude of sound variation (e.g., in decibels, also arising from a passing vehicle); and, magnitude of accelerometer reading.

The term “class” refers generally to the type/classification of a vehicle as observed within a road network. In the present context, “class” may be a designation of whether a vehicle is, for example, a motorcycle, car, van, bus, taxi, coach, heavy goods vehicle (HGV), light goods vehicle (LGV), or the like. Additional information pertaining to a specific “class” of vehicle (e.g., dimensions, maximum velocity, onboard safety features, indicative risk parameters) may be accessible, for example via a lookup database, to further aid in identification and/or classification of road events/incidents.

The term “occupancy” refers generally to the prevalence/quantity of vehicles within a predefined portion (e.g., within a specific lane and/or segment) of a road network in a given/specific timeframe. In the present context, it is calculated using the formula:

$$Occupancy ( in a lane , for a segment ) = \frac{{\sum }_{C l a s s e s} ( C a r s C o u n {t}_{C l a s s} * A v e r a g e L e n g t {h}_{C l a s s} )}{S e g m e n t L e n g t h}$$

The term “headway” refers generally to the average dispersal/spread distance between vehicles travelling within a predefined portion (e.g., within a specific lane and/or segment) of a road network within a given/specific timeframe. In the present context, it is calculated using the formula:

$$Headway ( in a lane ) = \frac{( 1 - Occupancy ) * Seg m e n t L e n g t h}{C a r s C o u n t}$$

The terms “tensor” or “road tensor” refer generally to a set of matrices defining, for a given time interval and for a predefined portion of a road network, a number of recorded observable parameters. In the present context, a “road tensor” may collectively define (e.g., in the form of a set of discrete matrices): the average traffic speed (e.g., for each lane within a number of predefined road segments) in a given time interval; the vehicle count (e.g., for each lane within a number of predefined road segments) in a given time interval; and, sensing metrics (e.g., for each lane within a number of predefined road segments) in a given time interval.

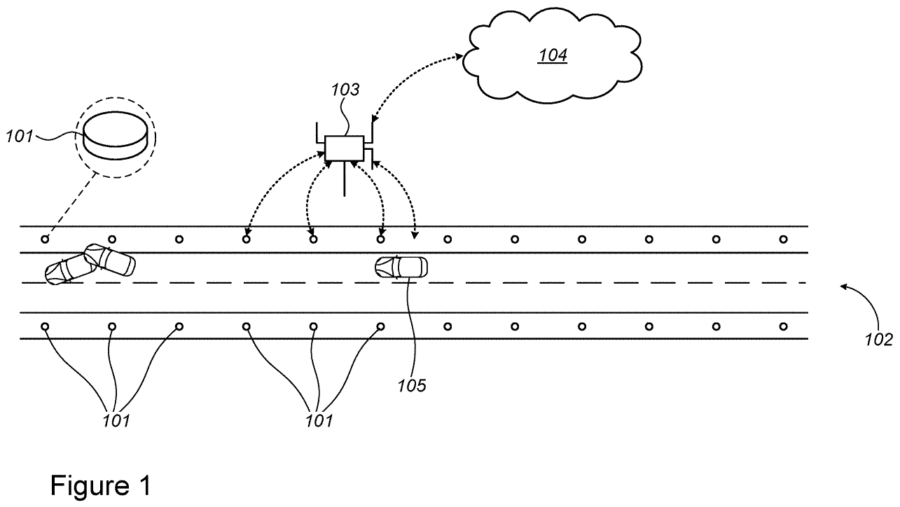

FIG. 1 illustrates exemplary non-limiting architecture of a system for traffic and road condition identification and classification according to embodiments of the present invention. A plurality of road stud units 101 are installed, preferably at uniform/regular intervals (e.g., every 10 meters), proximate to a highway 102 (e.g., at either side and/or in a peripheral/boundary location). Preferably each road stud unit 101 is a “Dynamic Road Marker” as disclosed by Bahiri et al. in US Patent Application Publication Number 2017/0002527 A1, which is incorporated herein by reference. Each road stud unit may collect information about vehicles and weather conditions in its vicinity and may send the information wirelessly to one or more gateway stations 103. Each road stud unit 101 is equipped with one or more sensors/detectors operable to record metrics associated with the highway 102, ambient conditions (e.g., weather conditions) and/or vehicles 105 passing proximate to the road stud units 101. As will be appreciated by those skilled in the art, any of acoustic sensors, magnetic field sensors, capacitive sensors, temperature sensors and/or radar sensors may be included within a road stud unit 101.

Each of the plurality of road stud units 101 are communicatively connected, via wired or wireless means, to one or more gateway stations 103. Preferably the gateway stations 103 are uniformly/regularly interspersed at, for example, 500-1000 meter intervals. Preferably each gateway station 103 is operable to communicate with multiple road stud units 101 (e.g., 200 or more road stud units). Preferably each gateway station 103 may be further operable to communicate with passing connected cars using vehicle-to-infrastructure communication. Each gateway station 103 may manage and collect data from a plurality of road stud units 101 and may send the sorted and compressed information to a remote processing facility 104.

Each gateway station 103 is further communicatively connected, via wired or wireless means, to a remote processing facility 104 operable to collect information from all gateway stations 103, and optionally also from traffic monitoring infrastructure and/or connected vehicles, and to perform analysis/assessment thereupon. Each gateway station 103 may collect information in real time from gateway station 103, may analyze the information in a cohesive way in order to make the relevant information accessible to all road users and operators. Preferably the communicative connections between road stud units 101, gateway stations 103, and the remote processing facility 104 are achieved wirelessly using one or more data protocols, such as Long Range (LoRa), Global System for Mobile Communications (GSM), Dedicated Short Range Communications (DSRC), and/or Global Positioning System (GPS). Preferably the communicative connection between each road stud unit 101 and gateway station 103 is achieved using Long Range (LoRa) data protocols. Preferably the communicative connection between each gateway station 103 and remote processing facility 104 is achieved using Global System for Mobile Communications (GSM) data protocols.

In some embodiments, one or more gateway station 103 may be further communicatively connected with one or more vehicles 105 (e.g., via a vehicle-to-infrastructure (V2I) link) and/or with one or more external/unassociated tracking/sensing systems (e.g., camera monitoring infrastructure, or the like). It will be appreciated that the one or more vehicle and/or one or more external/unassociated tracking/sensing systems may each comprise independent sensing equipment, metrics from which may be supplied to gateway station 103 and therefrom forwarded to the remote processing facility 104 for subsequent analytics. Preferably the communicative connection between each gateway station 103 and vehicle 105 is achieved using Dedicated Short Range Communications (DSRC) data protocols.

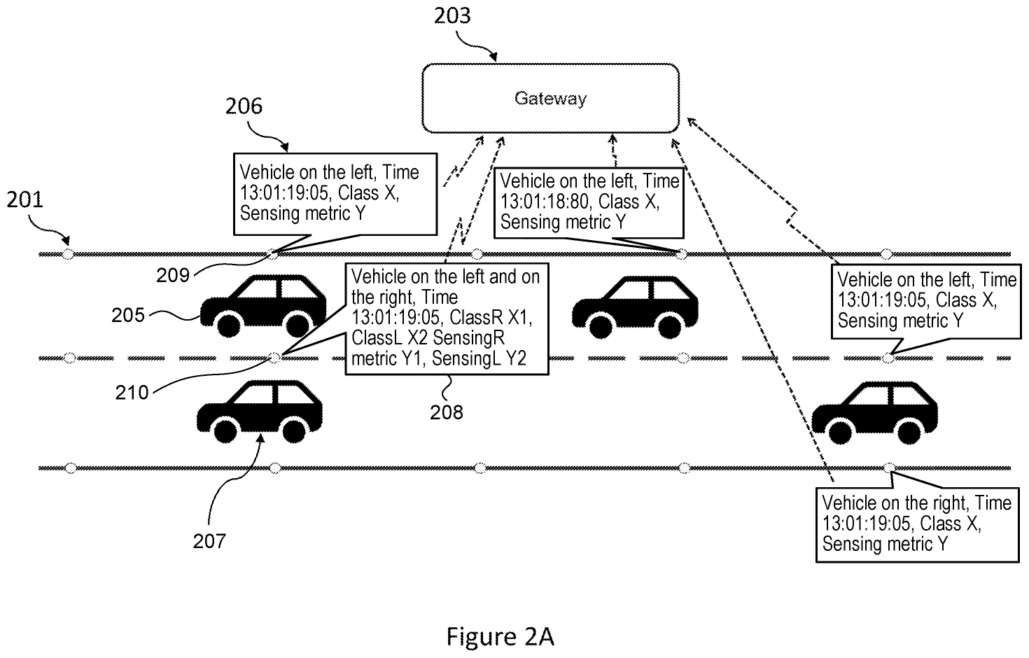

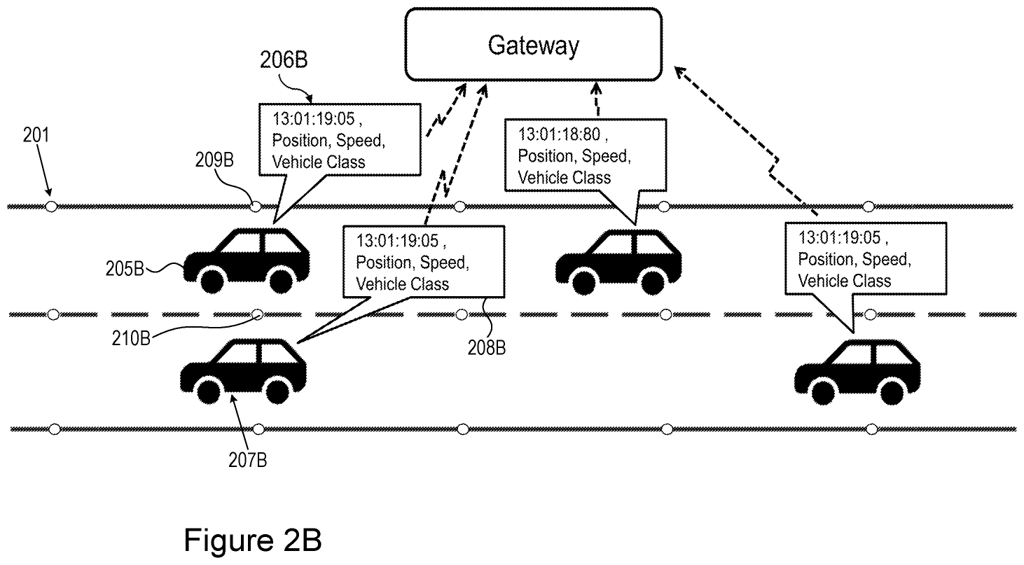

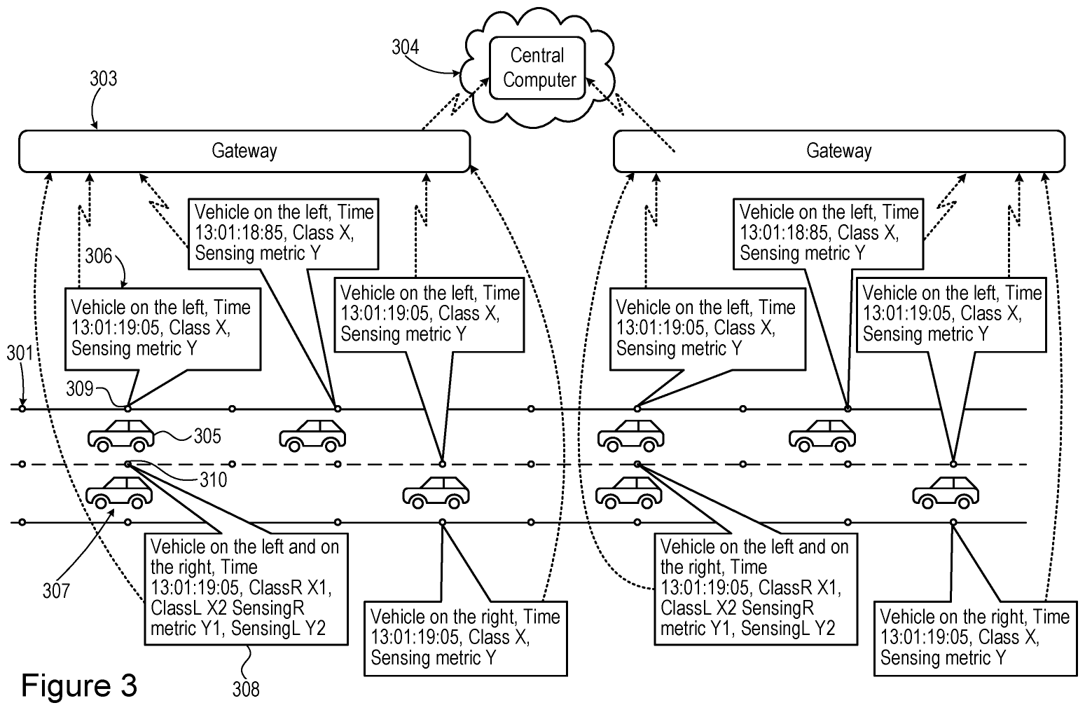

FIGS. 2A, 2B and 3 are schematic diagrams illustrating data acquisition and flow according to embodiments of the present invention. Each road stud unit 201/301 is operable to sense, using one or more inbuilt sensors/detectors, parameters 206/306 associated with vehicles 205/305 passing nearby. Alternatively or additionally, one or more of the vehicles 205/305 may be a connected vehicle operable to collect and record parameters 206B. These parameters 206/206B/306 may include the class of the vehicle 205/305 and metrics associated with the vehicle 205/305, such as each vehicle's respective speed and direction of travel. Each parameter 206/206B/306 is further associated with a time interval and combined/packaged with other parameters 206/206B/306 (i.e., of that specific vehicle at that specific time interval) to denote a comprehensive description of a specific vehicle 205/305 for a given time interval. Each packaged vehicle description is transmitted to an associated gateway 203/303, and subsequently thereafter transmitted from the gateway 203/303 to a remote processing facility 304 for storage (e.g., in a database) and analysis. Preferably the remote processing facility 304 is cloud based. For example, parameter 206/306 associated with vehicles 205/305 passing nearby may include indication that a vehicle is on left of sensor 209/309, at time 13:01:19:05, the class of vehicle 205/305 is indicated as class X and the sensing metrics is indicated as metrics Y. Parameter 208/308 associated with vehicles 205/305 and 207/307 passing nearby may include indication that a vehicle is on left and on the right of sensor 210/310, at time 13:01:19:05, the class of vehicle 205/305 is indicated as class X1, the class of vehicle 207/307 is indicated as class X2 and the relative sensing metrics are indicated as metrics Y1 and Y2 respectively. Exemplary parameter 206B of FIG. 2B may include indication that vehicle 205B passed by sensor at time 13:01:19:05 and the class, speed and position of vehicle 205B. Exemplary parameter 208B of FIG. 2B may include indication that vehicle 207B passed by sensor at time 13:01:19:05 and the class, speed and position of vehicle 207B. Other exemplary parameters associated with other exemplary vehicles are shown in FIGS. 2A, 2B and 3.

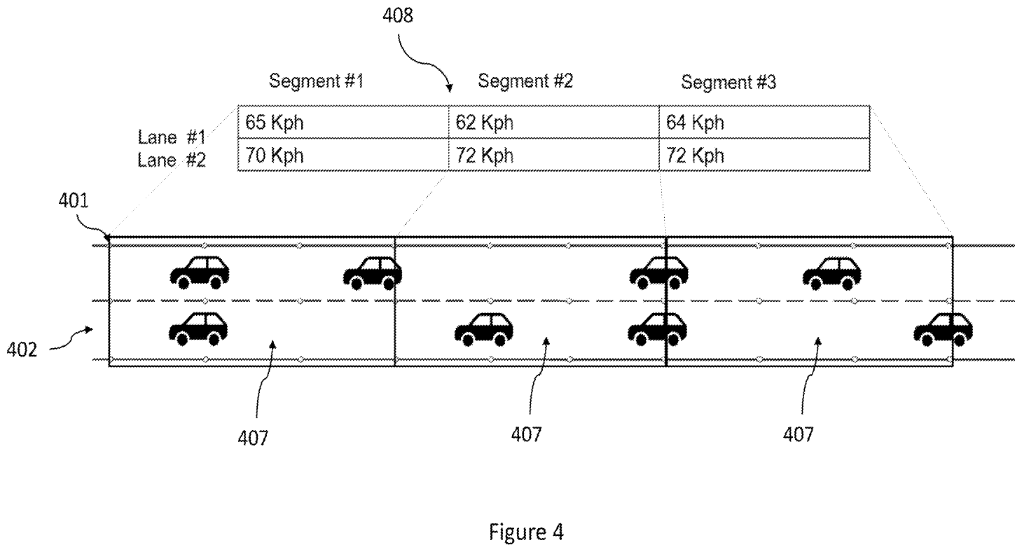

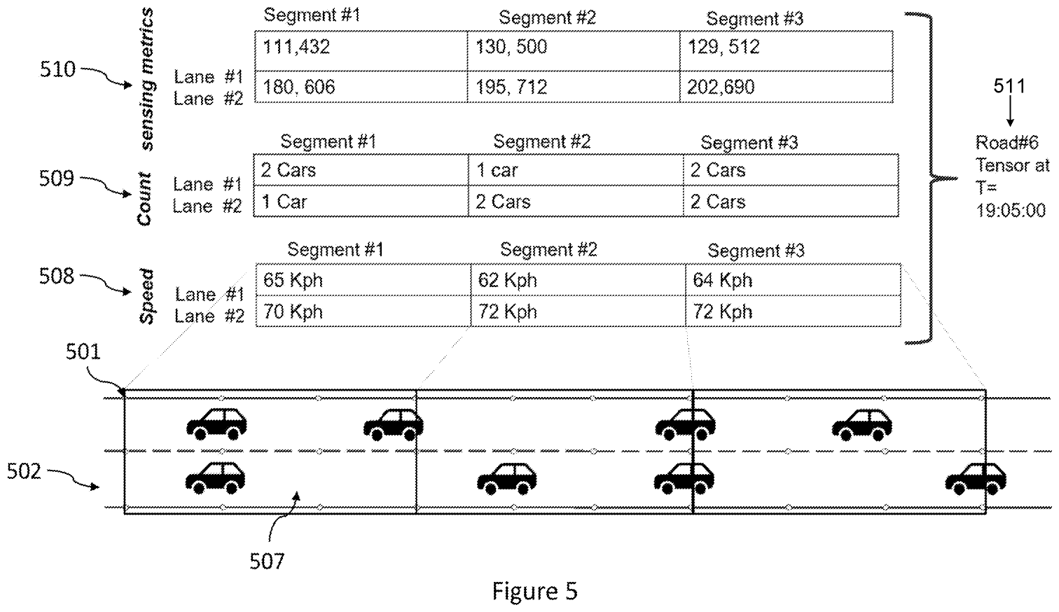

FIGS. 4 and 5 are schematic diagrams illustrating exemplary segmented road condition assessment according to embodiments of the present invention. Following receipt of a plurality of packaged vehicle descriptions, the remote processing facility 304 is operable to implement one or more data processing algorithms. These data processing algorithms may act to segment the available data into a plurality of discrete subsections 407/507 (e.g., 10-50 meters in length) where each subsection denotes a discrete portion of highway 402/502 for a given time interval. The data processing algorithms may also act to estimate the average traffic speed in each lane for every highway 402/502 subsection 407/507 and correlate this data into a representative vehicle speed matrix 408/508. Further matrices 509/510 may also be calculated to denote, for example, vehicle 405 count/occupancy and headway per subsection 407/507 (i.e., for that time interval) and/or vehicle 405 metrics per subsection 407/507, and thereafter combined to define a road tensor 511 for that given time interval.

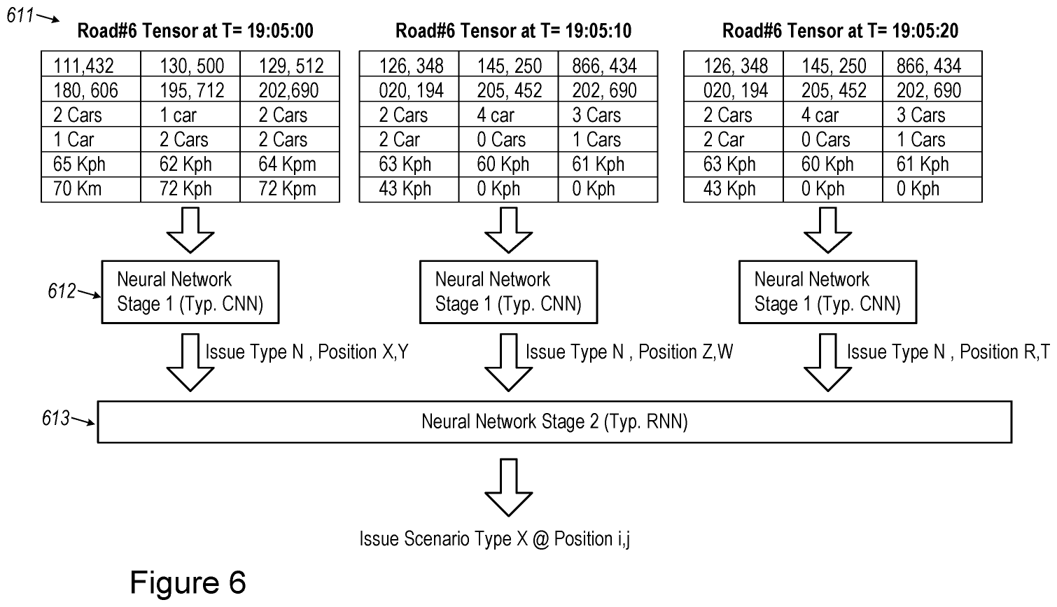

FIG. 6 is a schematic diagram illustrating an exemplary computational method for identifying and classifying traffic and road conditions according to embodiments of the present invention. A road tensor 511 for a specific portion of highway 502 is calculated as aforementioned for a number of consecutive time intervals. These consecutive road tensors 611 are then processed using machine learning algorithms, firstly to identify a possible road incident/event 612 and secondly to classify that road incident/event 613. In the first processing stage 612, for example, each road tensor 611 may be input into a neural network, such as a Convolutional Neural Network of type R-CNN (Region Convolutional Neural Network) or YOLO (You Only Look Once), which has been trained (e.g., based on significant historical road data and/or traffic simulations) to identify potential traffic incident/events. A non-exhaustive list of potential traffic incidents/events may include, for example, the presence of a road bound obstacle, an irregular slowdown, a stopped vehicle, a blocked lane, foreign object on the road, accident, wrong way driving of a vehicle and the like. Where a traffic incident/event is potentially identified, processing passes to the second stage 613 where a secondary neural network (e.g., of Recursive Neural Network structure, also possibly trained using historical road data and/or traffic simulations) is employed to extract time related traffic incident/event data to classify the incident/event. Progression of the incident/event during the consecutive time intervals may therefore be used to characterize and thus classify the incident/event. A non-exhaustive list of characterizations may include an issue scenario type and its position, for example: a static obstacle in position X; a moving passive obstacle in position Y travelling in direction Z; or, a path-thru obstacle such as a pothole, puddle, or the like.

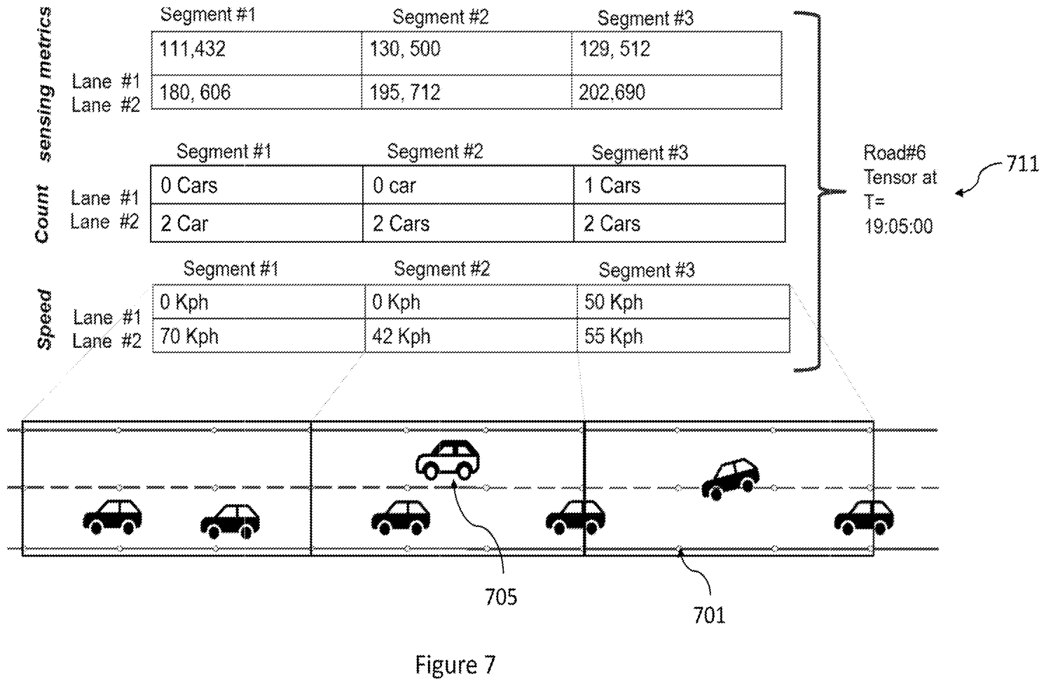

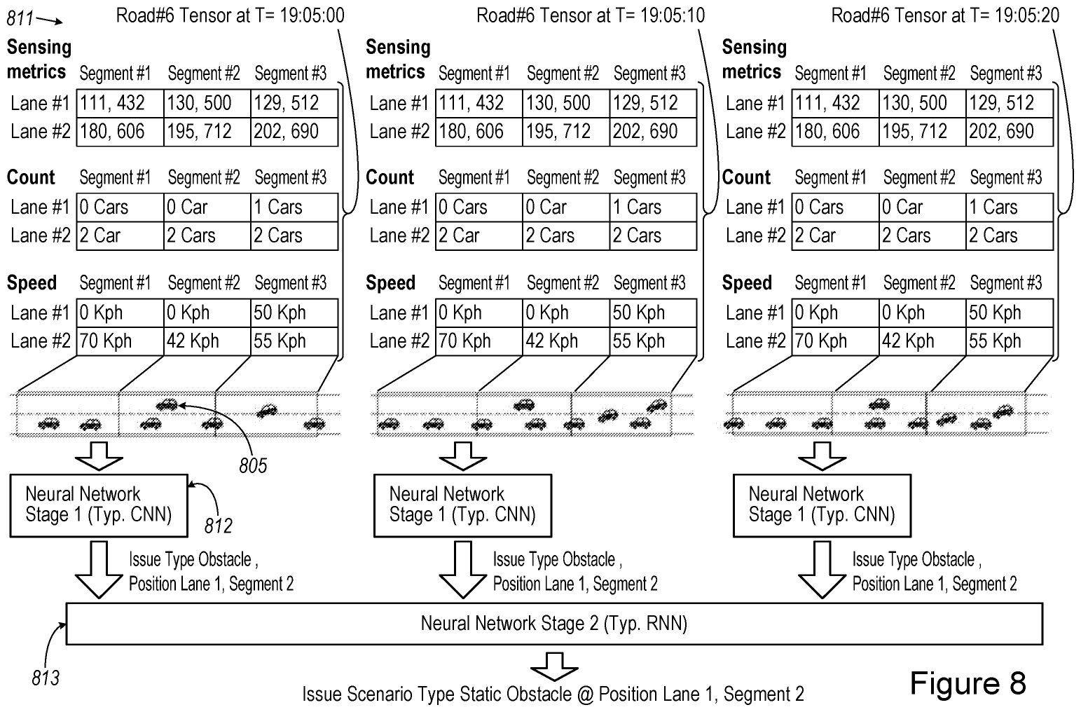

FIGS. 7 and 8 are schematic diagrams illustrating an exemplary traffic and road condition classification and its progression according to embodiments of the present invention. In this example, a vehicle 705/805 has become stationary (e.g., stalled or broken down) thereby forcing other vehicles to switch lane in order to continue along their path of travel. Data from proximate road studs 701, traffic monitoring infrastructure and/or connected vehicles denoting this behavior is accumulated and transposed/sorted into a number of consecutive road tensors 711/811 which are then fed into machine learning algorithms, such as a two stage neural network 812/813. The neural networks then accordingly make a number of deductions from the available data in accordance with the training undertaken. For example, the neural networks may identify an incident (e.g., a stationary vehicle) and thereafter classify it (e.g., a stationary vehicle in lane 1, subsection 2). This information may then be disseminated to drivers and/or to connected vehicles in the locality to advise them of the incident/event, possibly thereby enabling evasive action and/or precautionary rerouting. Alternatively or additionally, the information may be made available to a manned or unmanned control center, possibly thereby facilitating expedited dispatch of emergency services, or the like.

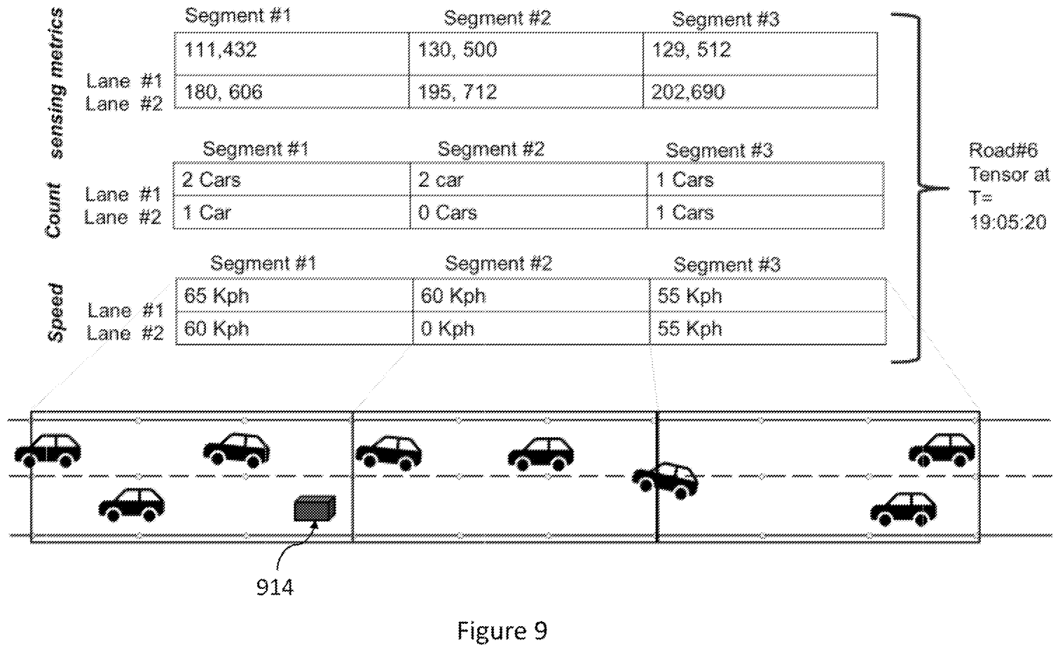

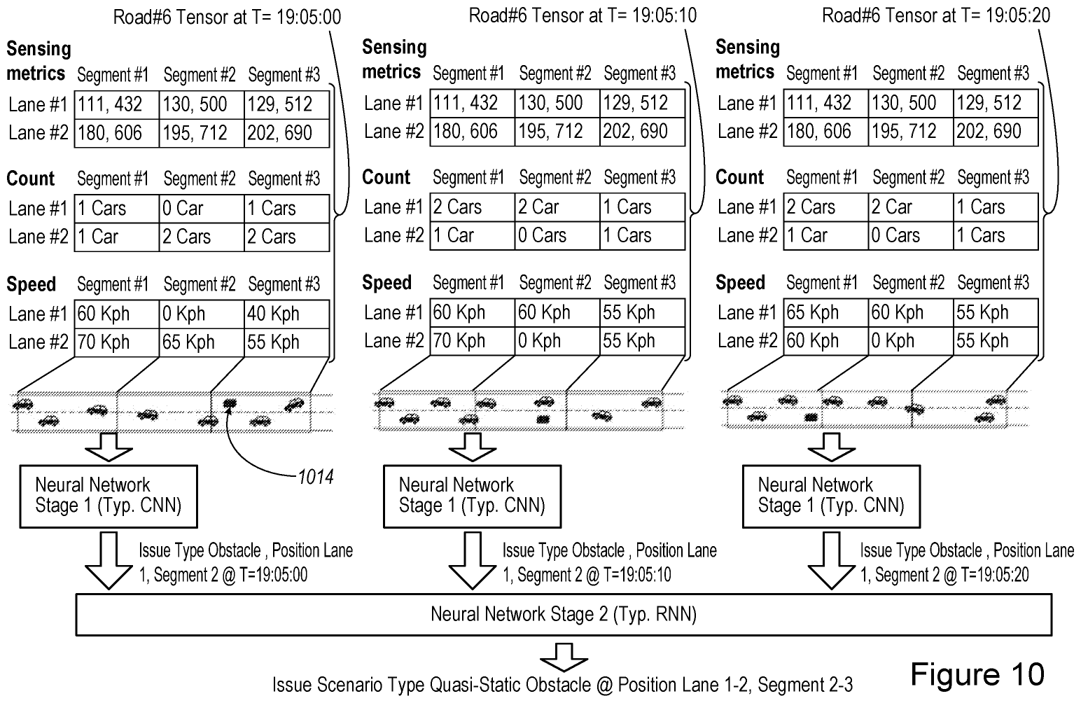

FIGS. 9 and 10 are schematic diagrams illustrating an alternative exemplary traffic and road condition classification and its progression according to embodiments of the present invention. In this example, a quasi-static obstacle 914/1014 (e.g., a paper box, possibly being blown around in the wind) has triggered erratic driver behavior in both driving lanes. As before, the machine learning algorithms make a number of deductions from the available data. For example, the machine learning algorithms may observe frequent changes in vehicle count for each lane, and further erratic changes in vehicle speed for both lanes. Cumulatively these observations may be combined to identify an incident (e.g., a road bound obstacle) and thereafter classify it (e.g., a road bound obstacle moving in direction Z between lanes 1 and 2).

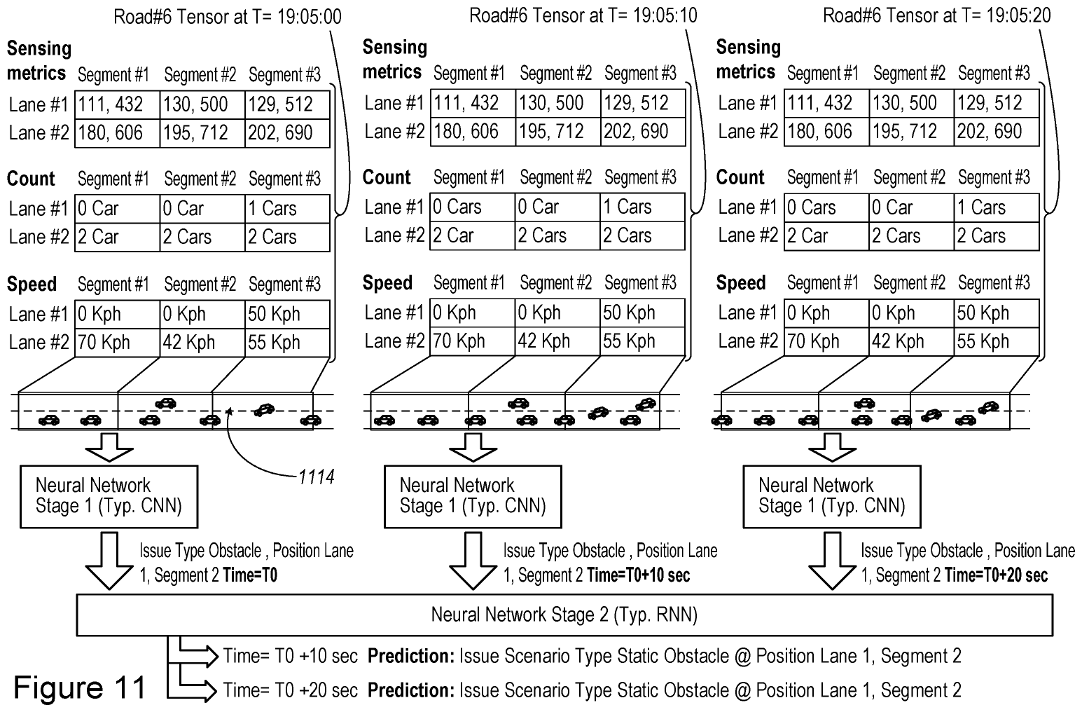

FIG. 11 is a schematic diagram illustrating exemplary prediction of a traffic and road condition according to embodiments of the present invention. In this example, a vehicle 1114 instantaneously breaks down at time T0 and begins obstructing other vehicles from proceeding along that lane. The machine learning algorithms make a number of observations at time T0+10 seconds and T0+20 seconds and therefrom calculate the likelihood of an evolving traffic and road event. In the seconds immediately following vehicle 1114 breaking down, the resultant buildup of traffic may be minor and may indicate limited event likelihood, possibly not warranting of immediate remedial measures. The machine learning algorithms may however predict and/or observe that the situation worsens over time, for example owing to an anticipated increase in traffic flow through this region, and may accordingly ascertain a requirement for future preventative measures (e.g., the dispatch of breakdown recovery vehicle). Other road or traffic observations which may give rise to a predicted/evolving event include: observing a rapid slowdown of multiple vehicles in a specific location and an associated increase in accident probability at that location; abnormally slow traffic in a lane and an associated likelihood that this will lead to a traffic jam; and, multiple vehicles changing lane at a specific location and an associated indication of an obstruction at that location.

It will be appreciated by those skilled in the art that machine learning algorithms according to embodiments of the present invention may be trained using a variety of approaches. Principally training may be achieved using simulated or real life data sets where parameters are tailored or engineered so as to converge at specific expected results. Subsequently training may be incrementally advanced and refined by introducing further data sets, possibly including data collected by the deployed system itself. Positive verification of correct event identification and/or classification may be acquired in a number ways, including: operators and/or users providing feedback; cross referencing with third party systems monitoring the same events; and, cyclic prediction and subsequent observation to determine prediction accuracy (i.e., “self-learning”).

Further, it will be appreciated by those skilled in the art that the performance and training rate of machine learning algorithms according to embodiments of the present invention may be enhanced using transfer learning concepts. For example, where a new road section is introduced, it may be possible to compare this road section to known road sections and import relevant teachings to expedite the training process. It may also be possible to routinely perform cross referencing between alike portions of road and thereby continually exchange relevant teachings to improve overall identification and classification accuracy.

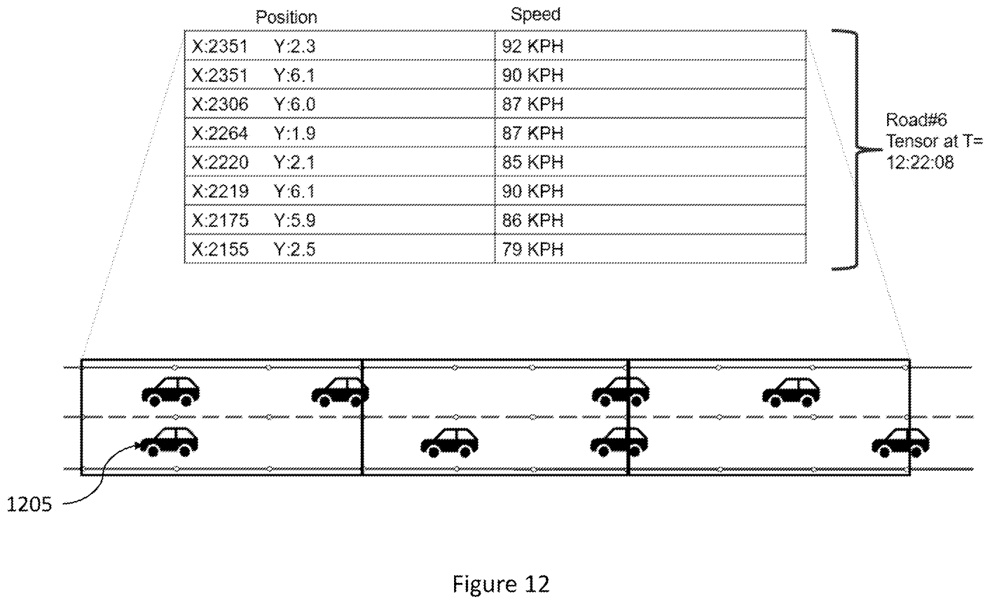

FIG. 12 is a schematic diagram illustrating an exemplary means for obtaining metrics data directly from connected vehicles according to embodiments of the invention. Each connected vehicle 1205 comprises one or more sensing device operable to record metrics data, such as position and speed data, regarding itself (i.e., if monitored) and/or other proximate monitored vehicles. These metrics data may then be transmitted periodically, for example up to 10 times per second, to a local gateway station and processed to ascertain the geographical positioning (e.g., latitude, longitude) of the monitored vehicles within each lane (e.g., its X and Y coordinate relative to lane boundaries).

According to some embodiments of the invention, the machine learning algorithms may comprise one or more Naïve Bayes Classifiers. A road tensor may be input, updated periodically, and compared to labeled tensors using the formula:

$$p ( {C}_{k} \vert x ) = \frac{p ( {C}_{k} ) p ( x \vert {C}_{k} )}{p ( x )}$$

where the probability of a road tensor X being classified as a road event of class Cₖ is equal to the probability of a road event of class Cₖ occurring multiplied by the probability of obtaining a road tensor of type X given event Cₖ, all divided by the probability of having road tensor X. This may then be classified by assessing which class has the greatest probability (i.e., finding the class K with the highest probability) using the formula:

$$\hat{y} = {argmax}_{k ∈ \{ 1 , … , K \}} p ( {C}_{k} )$$

It will be appreciated by those skilled in the art that classifiers of this type are known to improve in performance over time owing to the probability vectors p (Cₖ), p(x|Cₖ) being continuously updated (i.e., as more events are added from the road, from similar roads, or from simulations, etc).

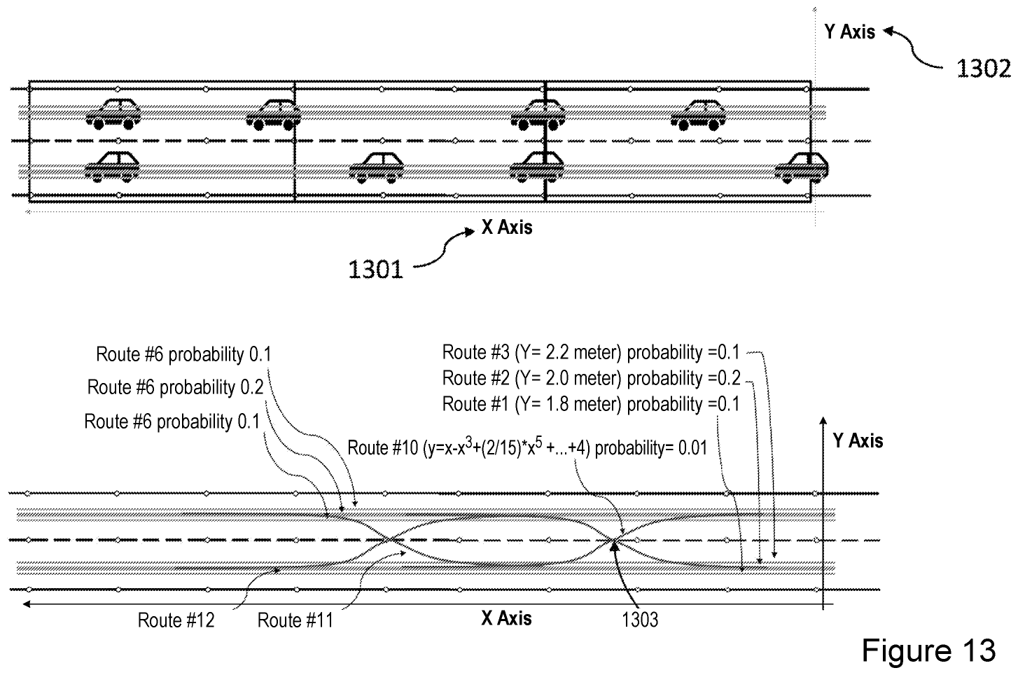

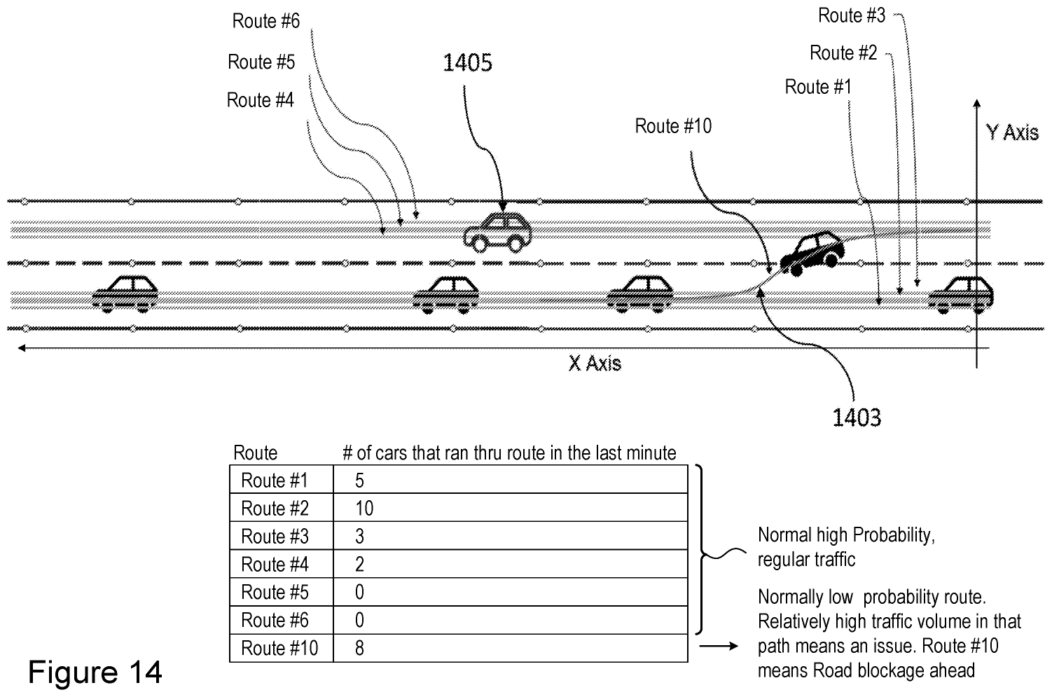

FIGS. 13 and 14 are schematic diagrams illustrating an exemplary means for identifying and classifying traffic and road events using polynomial K-means clustering machine learning algorithms according to embodiments of the invention. A polynomial representation of a route along a road segment is defined, for example where an X-axis 1301 extends along the road in the direction of traffic flow, and a Y-axis 1302 extends perpendicularly across the road. Training using live road samples and/or simulation data is then conducted to determine polynomial coefficients relating to a number of routes through which traffic may flow along the road segment, and to identify the respective probability of each of these routes. The polynomial representation may denote, for example, the positions (in terms of X and Y coordinates) where vehicles change lanes 1303 in a given route. These routes may then be sorted according to probability and compared with the actual routes taken by monitored vehicles to ascertain divergence and/or irregular activity. For example, the route most closely matching the actual route taken by a number of monitored vehicle may be determined and, in the event that irregular activity is found among multiple successive vehicles, a traffic event may be identified. Further, if the irregular activity is a known and/or recognizable phenomenon (e.g., multiple vehicles changing lanes owing to a blockage) the identified traffic event may be classified accordingly.

FIG. 14, for example, illustrates such a scenario where a vehicle 1405 has broken down forcing all following vehicles to abruptly change lane 1403. A route associated with this event (“Route #10”) is observed to have become uncharacteristically popular. Meanwhile, the routes more typically observed to be followed through this road segment (“Route #5” and “Route #6”) have become uncharacteristically unpopular. Cumulatively the polynomial K-means clustering algorithm therefore ascertains that a traffic event is in progress and, further, that the event relates to a broken down vehicle 1405 impeding traffic flow in one lane of traffic (i.e., a phenomena recognizable from training data). It will be appreciated by those skilled in the art that polynomial K-means clustering algorithms of the type proposed herein may be continually and/or iteratively updated to improve efficacy. This may include, for example, updating polynomial coefficients and/or probability assessments for any given route in accordance with observed behaviors (e.g., owing to different driving behaviors at different times of day, etc).

According to some embodiments of the invention, weather related data may be associated with classifications derived by the machine learning algorithms to enrich/clarify the observations. For example, where the classification indicates, as aforementioned, a stationary vehicle in lane 1, weather data relating to this area may be incorporated to reveal that there has been severe rainfall and that the vehicle has become stuck owing to floodwater.

According to some embodiments of the invention, weather related data may be obtained and imported from an external data source, such as a national meteorological agency or the like.

According to some embodiments of the invention, the recording time intervals may be 10 seconds or less.

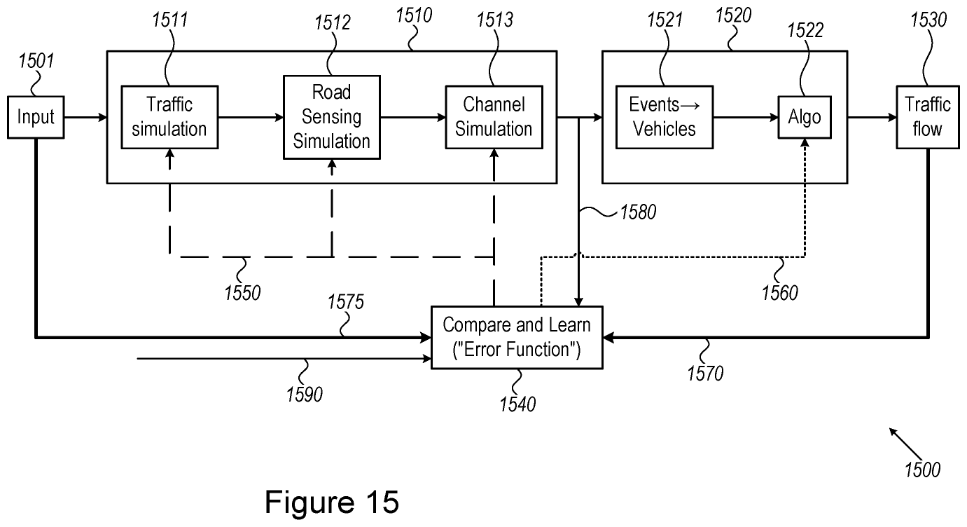

FIG. 15 is a schematic flow diagram illustrating an exemplary computational method for identifying and classifying traffic and road conditions according to embodiments of the present invention. Diagram 1500 illustrates exemplary computational method for training one or more machine learning algorithms with the aid of traffic simulation for algorithms training to derive traffic and road events and associating using said one or more machine learning algorithms, one or more observed traffic and road events with a known class of traffic and road event. Embodiments of the invention may allow to observe, identify, or monitor traffic pattern which may be identified as abnormal, irregular, or unusual traffic pattern and may classify that traffic pattern which relate to a plurality of vehicles.

According to embodiments of the invention training one or more algorithms for detection and classification may include a plurality, a large number, e.g., hundreds, thousands or other numbers of cases or instances of irregular traffic events to train on. Gathering information from limited length live road of irregular traffic events may take years and not be efficient and therefore simulated cases or simulated monitored vehicles and/or traffic patterns may be used in addition to data gathered or collected from the real road. In order to create a simulation reliable enough, e.g., such that an output of the simulation may represent a road accurately, a first stage of the training may include training a simulation to monitor normal traffic flow accurately while a second stage of the training may include training an algorithm to identify incidents or events. Both stages may include use of a simulation block 1510 and the second stage may include use of a monitoring system computation block 1520. Simulation block 1510 may include a traffic simulation block 1511, a road sensing simulation block 1512 and a channel simulation block 1513.

The first stage of the training may include operating simulation block 1510 over input 1501 which may give a best outcome versus normal traffic that the system monitors. Output 1580 may be compared with input 1590 which may include information received from real sensing system of road stud units by a compare and learn block 1540 with a target of reducing the computed difference or error between input 1590 and output 1580 to a minimum error hence replicating or simulating the real world traffic accurately. Configuration parameters of simulation blocks 1511, 1512 and 1513 may be changed iteratively, as indicated by arrow 1550, as a function of the computed error until the computed difference between input 1590 and output 1580 reaches a predefined minimum value. It may act as a duplicated monitoring system which use specific road, specific traffic behavior and other sensing artifacts as an input. When the simulation output reaches a predefined level of accuracy, e.g., resemble to output of normal traffic, incidents and events may be used to train algorithms during the second stage of the training by monitoring system computation block 1520 which may be used for identifying and classifying events. The first stage may be used to collect reference data based on live, real traffic, and then use it to enable a very reliable and realistic training for identification and classification of uncommon events on live road thru simulation

During the first stage of the training, simulation block 1510 may be configured to simulate real, live, normal traffic in a road of target. Simulation block 1510 may receive a plurality of road parameters, traffic parameters, traffic rules and/or traffic incidents as configuration input 1501. Traffic simulation block 1511 may simulate real traffic behavior, e.g., how dense is the traffic, typical distance between cars, common drivers' behavior, and the like over a simulated road topography as defined by the configuration parameters e.g., number of lanes, curves, lane merges and the like. Road sensing simulation block 1512 may simulate sensing characteristics for example, accuracy of car in-lane position, traffic sampling imperfections and biases, speed estimation error rate of road stud units and the like. Channel simulation block 1513 may simulate the information distortions caused by the communication channel, between the sensor of the road stud units and the remote processing facility or cloud computation platform, e.g. losing some of the sensing data or having it received asynchronously with other data

Output 1580 from simulation block 1510 may be compared by compare and learn block 1540 with input 1590 which may include information received from real sensing system of road stud units that may be captured from the real road where the road stud units are located. The simulation block parameters, e.g., of traffic simulation 1511, sensing simulation 1512 and channel simulation 1513 may be tuned to minimize the error such that the simulation during first stage of the training simulates very reliably the system behavior over normal traffic. The tuning may be achieved by changing the parameters used by simulation blocks 1511, 1512 and 1513 based on the computed error calculated by compare and learn block 1540, as indicated by arrow 1550. Algorithm block 1522, may be adapted and changed by changing parameters used by algorithm, block 1522 based on the computed error calculated by compare and learn block 1540, as indicated by arrow 1560 to minimize the identification and classification error as.

During the second stage of the training, simulation block 1510, may be configured to simulate traffic events and road conditions and monitoring system computation block 1520 may receive as an input the output from simulation block 1510 or data from live road where the sensors are placed as training reference. Monitoring system computation block 1520 may include events to vehicles processing block 1521 which includes the algorithm which may process the sensors sensing data from road stud units into information about vehicles that passed nearby those sensors and an algorithm block 1522 which may be trained to identify events and incidents. Compare and learn block 1540 may receive traffic flow output 1530 as an input, as indicated by arrow 1570 and in addition may receive input 1501 as another input, as indicated by arrow 1575. Compare and learn block 1540 may compare the outcome of the system, namely output 1530 with the configuration input 1501, derive the difference, the error, and change the parameters of the algorithm 1522, to minimize the error, hence apply a learning action.

According to some embodiments of the invention, inputs to the machine learning algorithms may comprise partial tensors (e.g., partial sensing metric data).

According to some embodiments of the invention, the machine learning algorithms may comprise only a single composite processing stage.

According to some embodiments of the invention, each machine learning algorithm may continuously review incident/event data to refine its identification and classification processes. In yet further embodiments of the invention, each machine learning algorithm may be self-learning.

According to some embodiments of the invention, the identifying and classifying may comprise—training one or more machine learning algorithms to derive traffic and road events; and, associating, using said one or more machine learning algorithms, one or more observed traffic and road events with a known class of traffic and road event.

It will be appreciated by those skilled in the art that machine learning (ML) may denote the application or use of artificial intelligence to enable a system to automatically learn and improve from experience (e.g., by analyzing patterns, drawing inferences, or the like), generally without requiring explicit instructions and/or programming in respect of the same.

According to some embodiments of the invention, the method may further comprise associating weather related data and/or externally acquired data with one or more classified and localized traffic and road events to clarify the nature of the classification.

According to some embodiments of the invention, the machine learning algorithm is a neural network and the identifying and classifying may be conducted in two separate stages: a first stage based on a convolutional neural network (CNN) to identify one or more traffic and road events, and a second stage based on a recurrent neural network (RNN) to classify each of said traffic and road events.

According to some embodiments of the invention, the method may further comprise determining and sending an alert related to one or more of said traffic and road events to one or more of: an external device; a graphical user interface (GUI); and, a control center.

According to some embodiments of the invention, the external device may be a device of an operator of said road.

According to some embodiments of the invention, the external device may be a device of an intervention force.

According to some embodiments of the invention, the method may further comprise sending an alert related to one or more of said traffic and road events to one or more monitored and/or unmonitored vehicles.

According to some embodiments of the invention, the method may further comprise sending a message related to said one or more traffic or road events to said plurality of stationary sensors, to activate precautionary light emitters connected thereto.

According to some embodiments of the invention, metrics data may be transmitted from said plurality of stationary traffic sensors to said at least one remote processing facility via one or more gateway stations.

According to some embodiments of the invention, the instructions to identify and classify one or more traffic and road events comprises: training one or more machine learning algorithm to derive traffic and road events; and, associating, using said one or more machine learning algorithm, one or more observed traffic and road events with a known class of traffic and road event.

According to some embodiments of the invention, the system may further comprise program instructions to associate weather related data and/or externally acquired data with one or more classified and localized traffic and road events to clarify the nature of the classification. The externally acquired data may include one or more of: data from road bound camera monitoring systems (i.e., road infrastructure); data from magnetic loop monitoring systems; and, data from interconnected and/or cloud warning systems (e.g., Google Maps, Waze, or the like).

According to some embodiments of the invention, the machine learning algorithm is a neural network and the program instructions to identify and classify one or more traffic and road events may be conducted in two separate stages: a first stage based on a convolutional neural network (CNN) to identify one or more traffic and road events, and a second stage based on a recurrent neural network (RNN) to classify each of said traffic and road events.

According to some embodiments of the invention, the system may further comprise program instructions to determine an alert related to one or more of said traffic and road events and to send said alert to one or more of: an external device; a graphical user interface (GUI); and, a control center.

According to some embodiments of the invention, the external device may be a device of an operator of said road.

According to some embodiments of the invention, the external device may be a device of an intervention force.

According to some embodiments of the invention, the system may further comprise program instructions to determine an alert related to one or more of said traffic and road events and to send said alarm to one or more monitored and/or unmonitored vehicles.

According to some embodiments of the invention, the system may further comprise: each one of said plurality of stationary traffic sensors further comprising at least one precautionary light emitter; said programs instructions further comprising program instructions to send a message related to one or more of said traffic and road events to each one of said plurality of stationary traffic sensors, to update said at least one precautionary light emitter.

According to some embodiments of the invention, traffic and road events may be identified and classified in respect of individual vehicles (e.g., an abnormal lane change, sudden braking, or the like) and/or in respect of multiple vehicles (e.g., collective/pack behavior, localized traffic buildup, or the like).

According to some embodiments of the invention, traffic and road events may develop slowly over time and may be identified and classified following extended observations (e.g., a pothole that slowly enlarges owing to weather erosion and/or wear from passing traffic).

According to some embodiments of the invention, identified and classified traffic and road events may be associated with immediate remedial action and/or long-term preventative action. For example, frequent traffic build up at a specific location may be associated with a remedial planning measure, such as the installation of new road signage, the widening of the road at a proximate junction, or the like.

According to some embodiments of the invention, training of the machine learning algorithms may comprise: incremental training based on one or more of: real-life historical data; and, simulated data; and, verification based on one or more of: operator and user feedback; cross-referencing with third party event data; and, continuous recursive prediction and outcome assessment.

According to some embodiments of the invention, training of the machine learning algorithms may further comprise continuously importing and sharing learning outcomes for alike portions of road.

According to some embodiments of the invention, one or more of said traffic and road events may be an evolving event classified and predicted by the machine learning algorithms to escalate in severity. According to some embodiments of the invention, one or more of said traffic and road events may additionally or alternatively be an associated event classified and predicted by the machine learning algorithms to occur as a consequence of one or more other events.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

As will be appreciated by one skilled in the art, aspects of the present invention may be embodied as a system or an apparatus. Accordingly, aspects of the present invention may take the form of an entirely hardware embodiment or an embodiment combining software and hardware aspects that may all generally be referred to herein as a “circuit,” “module” or “system.”

The aforementioned figures illustrate the architecture, functionality, and operation of possible implementations of systems and apparatus according to various embodiments of the present invention. Where referred to in the above description, an embodiment is an example or implementation of the invention. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions. It will further be recognized that the aspects of the invention described hereinabove may be combined or otherwise coexist in embodiments of the invention.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention may be implemented in the testing or practice with materials equivalent or similar to those described herein. While the invention has been described with respect to a limited number of embodiments, these should not be construed as limitations on the scope of the invention, but rather as exemplifications of some of the preferred embodiments. Other or equivalent variations, modifications, and applications are also within the scope of the invention. Accordingly, the scope of the invention should not be limited by what has thus far been described, but by the appended claims and their legal equivalents.

1. A method for automatically identifying and classifying traffic and road events, comprising:
collecting metrics regarding one or more monitored vehicles from at least one of: a plurality of stationary traffic sensors installed on or proximate to a discrete segment of a road; traffic monitoring infrastructure; and, one or more connected vehicles;
determining a position and a speed of each monitored vehicle per discrete segment in each lane of said road; and,
identifying, classifying and localizing one or more traffic and road events on said road, wherein said identifying and classifying comprises:
training one or more machine learning algorithms to derive traffic and road events; and,
associating, using said one or more machine learning algorithms, one or more observed traffic and road events with a known class of traffic and road event.

2. The method of claim 1, wherein said training comprises:
incremental training based on one or more of: real-life historical data and simulated data;
verification based on one or more of: operator and user feedback; cross-referencing with third party event data; and
continuous recursive prediction and outcome assessment of on one or more of: real-life historical data and simulated data.

3. The method of claim 2, wherein said training further comprises continuously importing and sharing learning outcomes for alike portions of road.

4. The method of claim 1, further comprising associating one or more of: weather related data; and, externally acquired data, with one or more classified and localized traffic and road events to clarify the nature of the classification.

5. The method of claim 1, wherein said one or more machine learning algorithms is a neural network, and wherein said identifying and classifying is conducted in two separate stages: a first stage based on a convolutional neural network (CNN) to identify one or more traffic and road events, and a second stage based on a recurrent neural network (RNN) to classify each of said traffic and road events.

6. The method of claim 1, wherein one or more of said traffic and road events is at least one of: an evolving event classified and predicted to escalate in severity, an associated event classified and predicted to occur as a consequence of one or more other events, a presence of a road bound obstacle, an irregular slowdown, a stopped vehicle, a blocked lane, an object on the road, an accident, wrong way driving of a vehicle.

7. The method of claim 1, further comprising determining and sending an alert related to one or more of said traffic and road events to one or more of: an external device; a graphical user interface (GUI); and, a control center.

8. (canceled)

9. (canceled)

10. The method of claim 1, further comprising sending an alert related to one or more of said traffic and road events to one or more monitored or unmonitored vehicle.

11. The method of claim 1, further comprising sending a message related to said one or more traffic or road events to said plurality of stationary sensors, to activate precautionary light emitters connected thereto.

12. The method of claim 1, wherein said training comprises:
training a simulation to accurately monitor real traffic flow based on live data from said road; and
training one or more machine learning algorithms by using output of said simulation to identify one or more traffic and road events.

13. A system for automatically identifying and classifying traffic and road events, comprising:
a plurality of stationary traffic sensors installed on or proximate to a discrete segment of a road, wherein each one of said plurality of stationary traffic sensors comprises:
a communication module for transmitting metrics data to at least one remote processing facility; and,
a sensing module for capturing metrics data regarding one or more monitored vehicles; and,
at least one remote processing facility comprising one or more computer processors each having computer readable storage media and program instructions stored thereon for execution by said one or more computer processors, the program instructions comprising:
instructions to receive metrics data from one or more of: said plurality of stationary traffic sensors; traffic monitoring infrastructure; and, one or more connected vehicles;
instructions to determine a position and a speed of each monitored vehicle per discrete segment in each lane of said road; and,
instructions to identify, classify and localize one or more traffic and road events on said road, wherein said instructions to identify and classify one or more traffic and road events comprises:
training one or more machine learning algorithms to derive traffic and road events; and,
associating, using said one or more machine learning algorithms, one or more observed traffic and road events with a known class of traffic and road event.

14. The system of claim 13, wherein metrics data is transmitted from said plurality of stationary traffic sensors to said at least one remote processing facility via one or more gateway stations.

15. The system of claim 13, wherein said training comprises:
incremental training based on one or more of: real-life historical data and simulated data;
verification based on one or more of: operator and user feedback; cross-referencing with third party event data; and
continuous recursive prediction and outcome assessment of on one or more of: real-life historical data and simulated data; and/or
wherein said training further comprises continuously importing and sharing learning outcomes for alike portions of road.

16. (canceled)

17. The system of claim 13, further comprising program instructions to associate one or more of: weather related data; and, externally acquired data, with one or more classified and localized traffic and road events to clarify the nature of the classification.

18. The system of claim 13, wherein said machine learning algorithm is a neural network, and wherein the program instructions to identify and classify one or more traffic and road events are conducted in two separate stages: a first stage based on a convolutional neural network (CNN) to identify one or more traffic and road events, and a second stage based on a recurrent neural network (RNN) to classify each of said traffic and road events.

19. The system of claim 13, wherein one or more of said traffic and road events is at least one of: an evolving event classified and predicted to escalate in severity, an associated event classified and predicted to occur as a consequence of one or more other events, a presence of a road bound obstacle, an irregular slowdown, a stopped vehicle, a blocked lane, an object on the road, an accident, wrong way driving of a vehicle.

20. The system of claim 13, further comprising program instructions to determine an alert related to one or more of said traffic and road events and to send said alert to one or more of: an external device; a graphical user interface (GUI); and, a control center.

21. (canceled)

22. (canceled)

23. The system of claim 13, further comprising program instructions to determine an alert related to one or more of said traffic and road events and to send said alarm to one or more monitored or unmonitored vehicle.

24. The system of claim 13, further comprising:
each one of said plurality of stationary traffic sensors further comprising at least one precautionary light emitter;
said programs instructions further comprising program instructions to send a message related to one or more of said traffic and road events to each one of said plurality of stationary traffic sensors, to update said at least one precautionary light emitter.

25. The system of claim 13, wherein said training comprises:
training a simulation to accurately monitor real traffic flow based on live data from said road; and
training one or more machine learning algorithms by using output of said simulation to identify one or more traffic and road events.
